(19) United States
(12) Patent Application Publication
(10) Pub. No.: US 2009/0014262 A1
(43) Pub. Date: Jan. 15, 2009

(54) Disc Brake and Brake Pad for a Commercial Vehicle

(75) Inventors: Jose Camilo-Martinez, Unterhaching (DE); Wolfgang Pritz, Aldersbach (DE)

Correspondence Address: CROWELL & MORING LLP;INTELLECTUAL PROPERTY GROUP, P.O. BOX 14300, WASHINGTON, DC, 20044-4300, US

(73) Assignee: Knorr-Bremse Systeme fuer Nutzfahrzeuge GmbH, Muenchen (DE)

(21) Appl. No.: 12/181,134

(22) Filed: Jul. 28, 2008

Related U.S. Application Data
(63) Continuation of application No. PCT/EP2007/000618, filed on Jan. 25, 2007.

(30) Foreign Application Priority Data
Jan. 26, 2006 (DE) 10 2006 003 748.0

(51) Int. Cl. B60T 1/06

(52) U.S. Cl. 188/2 R

(57) ABSTRACT

A disc brake for a commercial vehicle includes a caliper which, in use, straddles a brake disc. A closure cover closes-off an opening of the caliper. A brake pad includes a lining carrier plate and a friction lining material fastened thereon. The closure cover and the lining carrier plate have a respective elevation and recess which correspond to each other in a coded manner.

### CROSS-REFERENCE TO RELATED APPLICATIONS

This application is a continuation of PCT International Application No. PCT/EP2007/000618, filed on Jan. 25, 2007, which claims priority under 35 U.S.C. § 119 to German Application No. 10 2006 003 748.0, filed Jan. 26, 2006, the entire disclosures of which are expressly incorporated by reference herein.

### BACKGROUND AND SUMMARY OF THE INVENTION

The invention relates to a disc brake, in particular for a commercial vehicle, and also to a brake pad for a disc brake.

A disc brake of the generic type is disclosed in DE 199 07 958 A1, for example. What is shown and described in this document is that, in order to protect the inner compartment of the brake caliper, which accommodates actuating spindles of a brake application device, a mounting and functional opening of the caliper is closed off by way of a closure cover, such as plate-type cover. The closure cover is fastened to the caliper by use of screws.

In principle, it is possible when mounting the brake pads for improper mounting to occur, both through the use of an incorrect brake pad not intended and approved for the respective disc brake, and through mixing up the right and left brake pads when fitting them, in which case the brake pads can be mounted in a position in which they are effectively rotated by 180° without this being noticed. The result is that the lining carrier plate is then facing the brake disc. Since the brake disc is no longer operationally reliable, this improper mounting can result in serious and dangerous vehicle operating problems.

Apart from the afore-mentioned improper mounting, the known disc brakes also enable the brake pads to be replaced with external makes (for example, brake pads not from the original manufacturer), which are not approved for the particular vehicle or the particular disc brake.

This can also result in limiting the operational reliability of the disc brake, a situation which is fundamentally unacceptable, especially since disc brakes are among the components of a vehicle which are of particular importance from a safety point of view.

Although attempts have been made to code brake pads, the known codings can be removed by a simple mechanical operation, for example using a hammer and chisel, which means that uncoded brake pads of unauthorized manufacturers can be used without problems.

It is, therefore, an object of the invention to develop a disc brake that achieves an improvement in the operational reliability in combination with a low structural and manufacturing outlay.

According to the invention, a disc brake, particularly for a commercial vehicle, includes a caliper, which straddles a brake disc that is brought into operative contact with brake pads, each brake pad including a lining carrier plate and, fastened thereon, a friction lining. At least one closure cover closes off the caliper and is fastened thereon. The closure cover and the lining carrier plate have a respective elevation and recess which correspond to one another in a coded manner.

This structural design means that only a brake pad designated for this intended use can be mounted in the disc brake. It is ensured at the same time that the brake pad can only be used in such a way that its friction lining material side is oriented to face the brake disc.

Moreover, no external make or product can be used since the elevations and recesses of the closure cover on the one hand and of the lining carrier plate on the other hand that correspond to one another in the coded manner are compatible with one another only in a defined configuration.

This configuration, i.e., the shape and arrangement of the corresponding parts, is determined at the factory, which means that, as a replacement part, use can only be made of the brake pad which has the elevations and cutouts predetermined by the manufacturer of the disc brake.

In addition, the coding allows the prior determination of the brake pads for a specific point of installation. It is thus possible to exactly allocate brake pads with different coefficients of friction of the friction lining materials, as are required for an inner lining and an outer lining, in order, for example, to take account of the different cracking behavior of a brake disc. Any interchange between the two brake pads can thus be ruled out if the coding of the two brake pads or of the associated closure cover is different.

According to an advantageous configuration of the invention, provision is made for at least some of the screws, which are used to fasten the closure cover to the caliper, to serve as elevations, within the meaning of the invention, the screws, in particular the screw heads, being correspondingly modified to engage with recesses or cutouts adapted thereto in the lining carrier plate.

In a manner known per se, the screws are mounted in the peripheral region of the closure cover. Depending on the variation of their position within the periphery, a coding can be achieved, whereby brake pads intended exclusively for a predetermined type can be used which then have corresponding recesses, the screw heads of the screws projecting into the recesses.

A variation of the code can also be obtained by designing the screw heads differently, for example in terms of shape, diameter and length. Here, these differences, to which the recesses or cutouts of the lining carrier plate are adapted, can result in a large number of codes which, inter alia, can be used to rule out any interchange between the right and left brake pads.

A further advantage of the invention is that disc brakes in operation can be retrofitted, in which case the associated screws of the closure cover are then also replaced during a replacement of the brake pads. It is expedient in this case only to provide the coding facility by changing the shape, the length and/or the diameter of the screws.

A particular importance also attaches to the fact that the new disc brake can be produced with low manufacturing outlay. Since such disc brakes, and also in particular the replacement brake pads, are produced in large quantities, the invention offers the advantage of a significantly improved operational reliability with low outlay.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a detail of a disc brake according to the invention in a side view;

FIG. 2 shows a detail of the disc brake in a plan view; and

FIGS. 3-5 each respectively show an individual feature of the disc brake in a perspective view.

### DETAILED DESCRIPTION OF THE DRAWINGS

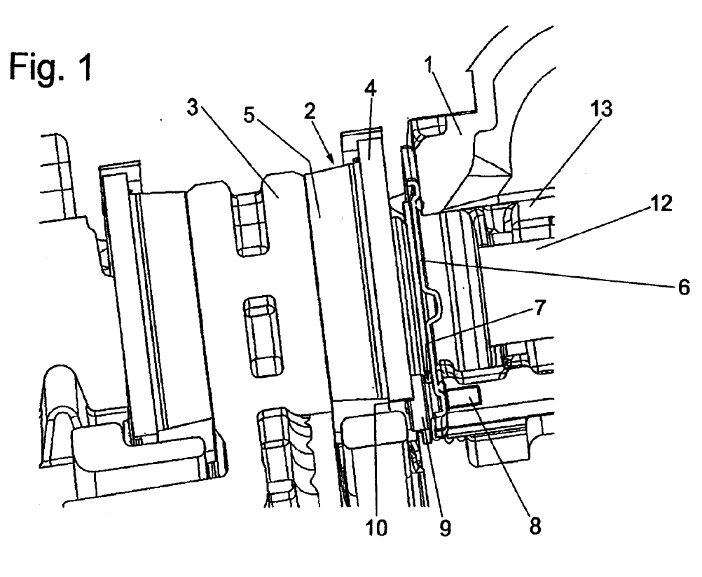

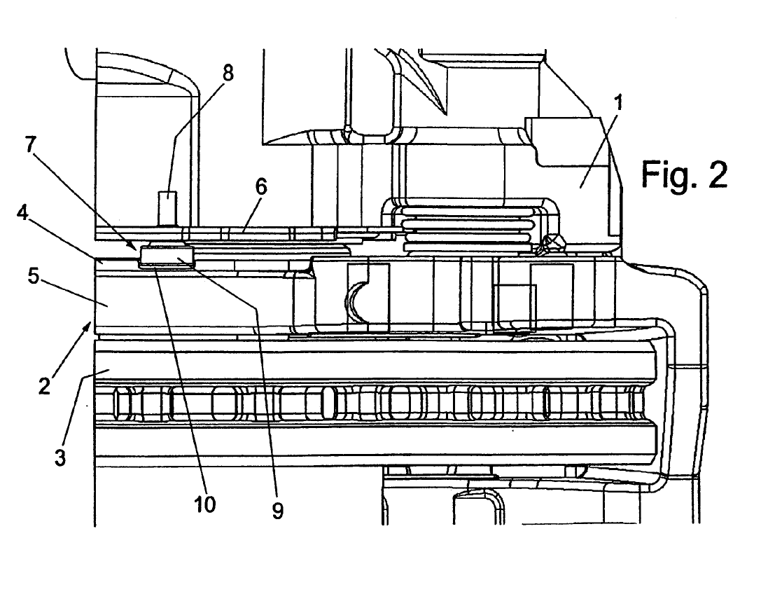

FIGS. 1 and 2 depict a disc brake, in particular for a commercial vehicle, with a brake caliper 1 which straddles a brake disc 3. Brake pads 2, each having a lining carrier plate 4 and a friction lining 5, can be brought into operative contact on both sides of the brake disc, wherein, the friction lining material 5 is pressed against the brake disc 3 during braking.

For this purpose, actuating spindles 12 are arranged in a mounting compartment 13 of the caliper. These spindles 12 (only one of which is shown) are connected on the one hand to a brake application device (not fully shown) and on the other hand bear against the lining carrier plate 4.

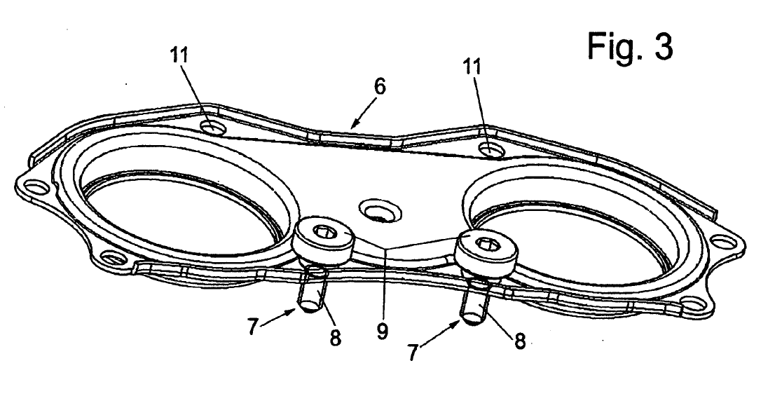

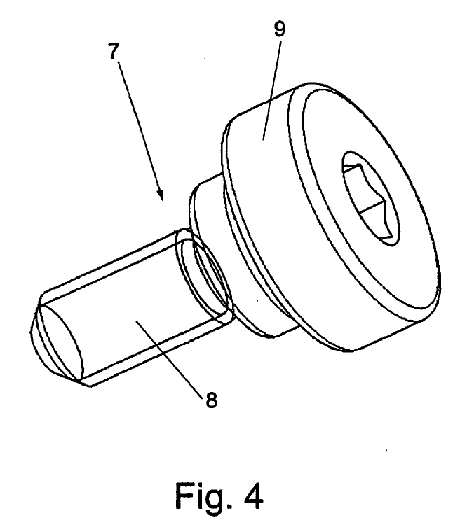

In the direction of the brake disc 3, the mounting compartment 13 is closed off by a closure cover or plate 6, specifically by use of screws 7 which are screwed peripherally into threaded holes in the caliper 1. The screws 7 are guided through holes 11 (FIG. 3) in the closure cover 6.

At least some of the screws 7 (in the present exemplary embodiment, two screws 7) are designed in such a way that they include a screw shank 8, which is screwed into the brake caliper 1, and a cylindrical screw head 9, which is produced as a separate part and connected to the respectively associated screw shank 8.

The screw head 9 forms an elevation which projects into a recess 10 in the lining carrier plate 4. The screw head 9 and the recess 10 correspond to one another in the manner of a coding facility. In other words, the screw heads 9 and the recesses or cutouts 10 are tailored to one another in their arrangement, configuration and dimensioning such that, when the closure cover 6 has been firmly screwed into place, only a correspondingly modified brake pad 2 can be used whose lining carrier plate 4 accommodates the screw heads 9 in the desired manner.

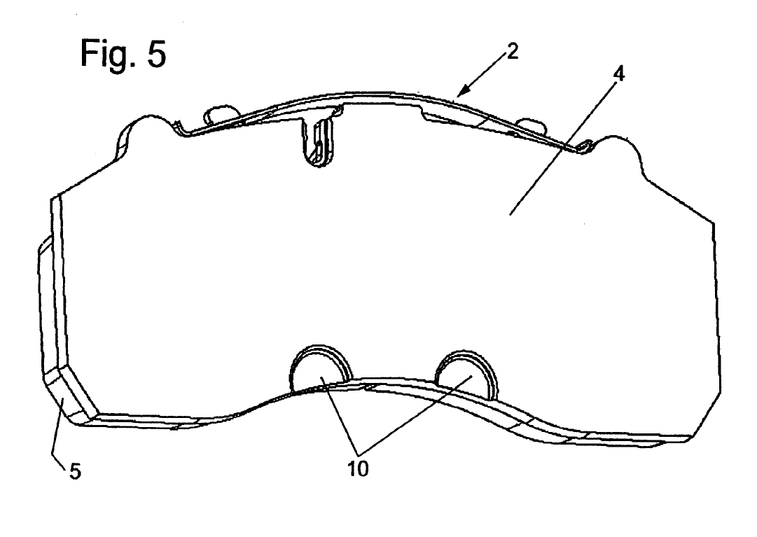

As shown very clearly, particularly in FIG. 5, the recesses or cutouts 10 (here, formed as blind cutouts) are open toward the bottom starting from the narrow side of the lining carrier plate 4.

Both the shape of the screw heads 9 and the dimensioning thereof can be freely selected such that a large variety of different codings can be achieved.

In order to facilitate simple mounting, in particular simple insertion of the brake pad 2 from above into the brake caliper 1, the screws 7 forming the elevations are expediently provided in the lower region (as viewed in the direction of insertion) of the closure cover 6.

### TABLE OF REFERENCE NUMBERS

1 caliper
2 brake pad
3 brake disc
4 lining carrier plate
5 friction lining
6 closure cover
7 screw
8 screw shank
9 screw head
10 cutout
11 hole
12 actuating spindle
13 mounting arm

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A disc brake having a brake disc, comprising:
a caliper which, in use, straddles the brake disc;
a closure cover operatively configured to close-off an opening of the caliper, wherein the closure cover is fastened to the caliper via screws;
a brake pad comprising a lining carrier plate and, fastened thereon, a friction lining material; and
wherein the closure cover and the lining carrier plate have a respective elevation and recess which correspond to each other in a coded manner.

2. The disc brake according to claim 1, wherein the elevation comprises a screw head of a screw that fastens the closure cover to the caliper, the screw head projecting into an associated recess in the lining carrier plate.

3. The disc brake according to claim 2, wherein the screw having the screw head is arranged on a lower edge region of the closure cover viewed in an insertion direction of the brake pad into the disc brake.

4. The disc brake according to claim 2, wherein the screw head is connected as a separate part to an associated screw shank, which screw shank is screwed into the caliper.

5. The disc brake according to claim 3, wherein the screw head is connected as a separate part to an associated screw shank, which screw shank is screwed into the caliper.

6. The disc brake according to claim 2, wherein the associated recess is operatively configured in form and dimensioning to the screw head.

7. The disc brake according to claim 3, wherein the associated recess is operatively configured in form and dimensioning to the screw head.

8. The disc brake according to claim 4, wherein the associated recess is operatively configured in form and dimensioning to the screw head.

9. The disc brake according to claim 1, wherein two elevations are provided, said two elevations comprising the screws used to fasten the closure cover to the caliper.

10. The disc brake according to claim 2, wherein two elevations are provided, said two elevations comprising the screws used to fasten the closure cover to the caliper.

11. The disc brake according to claim 1, wherein the recess is formed as a blind cutout on a rear side of the lining carrier plate facing the closure cover.

12. The disc brake according to claim 2, wherein the recess is formed as a blind cutout on a rear side of the lining carrier plate facing the closure cover.

13. The disc brake according to claim 3, wherein the recess is formed as a blind cutout on a rear side of the lining carrier plate facing the closure cover.

14. A brake pad for a disc brake having a closure cover for a caliper of the disc brake, the brake pad comprising:
a lining carrier plate;
a friction lining material fastened to the lining carrier plate; and
wherein the lining carrier plate comprises at least one recess operatively configured to accommodate in a coded manner the closure cover for the caliper.

15. The brake pad according to claim 14, wherein the recess is provided as a blind cutout on a rear side of the lining carrier plate facing away from the friction lining material.

16. The brake pad according to claim 14, wherein the recess is located on a lower edge region of the lining carrier plate.

17. The brake pad according to claim 15, wherein the recess is located on a lower edge region of the lining carrier plate.

18. The brake pad according to claim 14, wherein the recess formed in the lining carrier plate has an open edge opening to a narrow side of the lining carrier plate.

19. The brake pad according to claim 16, wherein the recess formed in the lining carrier plate has an open edge opening to a narrow side of the lining carrier plate.

20. The brake pad according to claim 14, wherein the recess is operatively configured to match a screw head of a screw utilized to secure the closure cover to the caliper.
